(19) United States
(12) Patent Application Publication
(10) Pub. No.: US 2025/0084911 A1
(43) Pub. Date: Mar. 13, 2025

(54) TORSIONAL VIBRATION DAMPER

(71) Applicant: Schaeffler Technologies AG & Co. KG, Herzogenaurach (DE)

(72) Inventor: David Schnädelbach, Ottersweier (DE)

(73) Assignee: Schaeffler Technologies AG & Co. KG, Herzogenaurach (DE)

(21) Appl. No.: 17/767,624

(22) PCT Filed: Sep. 11, 2020
(86) PCT No.: PCT/DE2020/100792

§ 371 Date: Apr. 8, 2022

(30) Foreign Application Priority Data
Oct. 11, 2019 (DE) 10 2019 127 399.4

(51) Int. Cl. F16F 15/14; F16F 15/134

(52) U.S. Cl. CPC F16F 15/145; F16F 15/134; F16F 2238/04

(57) ABSTRACT

A torsional vibration damper and a damping device having a torsional vibration damper includes at least one input part, an energy storage element and output part. The output part has a driver element and an output flange having at least one first flange portion extending in the circumferential direction and a second flange portion adjoining the first flange portion in the circumferential direction and extending in the circumferential direction. The output flange has a fastening end face extending over the first flange portion and the second flange portion. The driver part has a first connection portion extending in the radial direction and a bearing surface arranged on the end-face side. The first connection portion bears on the fastening end face. The output flange in the first flange portion has at least one fastening receiver. The fastening end face of the first flange portion is designed to bear on a bearing surface of a pendulum flange of a centrifugal force pendulum and the first fastening receiver is designed to receive a first fastener for fastening the pendulum flange in a rotationally fixed manner.

### CROSS-REFERENCE TO RELATED APPLICATIONS

This application is the U.S. National Phase of PCT Appln. No. PCT/DE2020/100792 filed Sep. 11, 2020, which claims priority to DE 10 2019 127 399.4 filed Oct. 11, 2019, the entire disclosures of which are incorporated by reference herein.

### TECHNICAL FIELD

The disclosure relates to a torsional vibration damper.

### BACKGROUND

DE 10 2013 201 981 A1 discloses a rotary vibration damper in a drive train of a motor vehicle. The rotary vibration damper has a dual-mass damper and a centrifugal force pendulum.

### SUMMARY

The problem addressed by the disclosure is that of providing an improved torsional vibration damper and an improved damping device for a drive train of a motor vehicle.

This problem is solved by means of a torsional vibration damper according to the disclosure. Advantageous embodiments are described herein.

It has been found that an improved torsional vibration damper for a damping device of a drive train of a motor vehicle can be provided in that the torsional vibration damper can be mounted so as to be rotatable about an axis of rotation, wherein the torsional vibration damper has at least one input part, an energy storage element and an output part, wherein the input part is rotatable against the action of the energy storage element about the axis of rotation relative to the output part, wherein the output part has a driver element and an output flange having at least one first flange portion extending in the circumferential direction and a second flange portion adjoining the first flange portion in the circumferential direction and extending in the circumferential direction, wherein the output flange has a fastening end face extending beyond the first flange portion and the second flange portion, wherein the driver element has at least one first connection portion extending in the radial direction, wherein the first connection portion rests against the fastening end face and is connected to the second flange portion, wherein the output flange in the first flange portion has at least one first fastening receiver, wherein the fastening end face of the first flange portion is designed to rest against a bearing surface of a pendulum flange of a centrifugal force pendulum and the first fastening receiver is designed to receive a first fastener for fastening the pendulum flange in a rotationally fixed manner.

This configuration makes it possible to optionally fasten a pendulum flange of a centrifugal force pendulum to the output flange of the torsional vibration damper, without the structural configuration of the torsional vibration damper having to be changed for this purpose. Thus, depending on the design of the damping device, the damping device can have the torsional vibration damper solely or have a centrifugal force pendulum. The driver element, together with the output flange, can delimit a retainer space at least in portions, the energy storage element being arranged at least in portions in the retainer space and being fastened by the driver element and the output flange.

In a further embodiment, the driver element has a second connection portion which is designed to be offset in the circumferential direction relative to the first connection portion, the first connection portion delimiting a web receptacle in the circumferential direction with the second connection portion, the output flange delimiting the web receptacle with the fastening end face in the axial direction, the first fastening receiver opening out at the web receptacle and the web receptacle being designed to receive a web portion of the pendulum flange. As a result, the first flange portion and first connection portion are arranged on a common pitch circle around the axis of rotation. As a result, the torsional vibration damper is compact in the radial direction.

It is particularly advantageous in terms of installation space in the axial direction if the first connection portion is designed radially on the outside of the driver element and is designed to be at least in portions in a plane of rotation to the axis of rotation.

In a further embodiment, a plurality of first fastening receivers arranged to be next to one another and to be offset relative to one another in the circumferential direction are provided in the first flange portion.

In a further embodiment, the output flange in the second flange portion has at least one second fastening receiver or a plurality of second fastening receivers arranged next to one another in the circumferential direction, wherein a second fastener engages in the second fastening receiver and connects the first connection portion to the second flange portion, wherein the first fastening receiver and the second fastening receiver have the same distance from the axis of rotation.

In a further embodiment, the first fastening receiver extends in the axial direction through the output flange, the fastening receiver being designed to be open radially outward at a first outer circumferential side of the output flange. As a result, the first fastener in particular, when configured as a rivet, can be positioned close to the outer circumferential side, such that the damping device is designed to be particularly compact in the radial direction.

In a further embodiment, the first fastening receiver has a first receptacle portion and a second receptacle portion arranged radially on the outside of the first receptacle portion, the first receptacle portion having a cross-section with a maximum first extension in the circumferential direction, wherein the second receptacle portion extends between the outer circumferential side and the first receptacle portion and opening both at the outer circumferential side and in the first receptacle portion, wherein the second receptacle portion has a second maximum extension in the circumferential direction, which is less than the first extension.

In a further embodiment, the first fastening receiver is unoccupied and the first flange portion is free.

The damping device for the drive train of a motor vehicle has the torsional vibration damper described above, a centrifugal force pendulum and at least one first fastener, wherein the centrifugal force pendulum has a pendulum flange, at least one pendulum mass and a coupling means, wherein the coupling means couples the pendulum mass to the pendulum flange and is designed to guide the pendulum mass along a predefined pendulum path, wherein the pendulum flange has a bearing surface arranged on the end-face side and a further fastening receiver, wherein the bearing surface of the pendulum flange rests against the fastening end face of the first flange portion, wherein the further fastening receiver and the first fastening receiver are at least partially aligned with one another, wherein the first fastener engages at least in portions in the first fastening receiver and the further fastening receiver and connects the pendulum flange to the output flange.

In this embodiment, the centrifugal force pendulum is also arranged on the torsional vibration damper so that rotational irregularities in a torque to be transmitted via the torsional vibration damper can be canceled particularly well. The torsional vibration damper and the centrifugal force pendulum can also be matched to different excitation frequencies so that two excitation frequencies can be canceled particularly well by means of the damping device. As a result, the drive train of the motor vehicle is particularly quiet overall.

In a further embodiment, the pendulum flange has at least one web portion designed to be at least in portions in a plane of rotation to the axis of rotation and an annular portion, wherein the annular portion is designed circumferentially around the axis of rotation, wherein the web portion is designed radially on the inside of the annular portion and extending radially inward, wherein the web portion engages in the web receptacle of the torsional vibration damper at least in portions.

### BRIEF DESCRIPTION OF THE DRAWINGS

The disclosure is explained in more detail below with reference to figures. In the figures:

FIG. 1 shows a functional circuit diagram of a drive train of a motor vehicle;

FIG. 2 shows a half longitudinal section through a structural configuration of the damping device shown in FIG. 1;

FIG. 3 shows a perspective view of an output part of the torsional vibration damper shown in FIG. 2;

FIG. 4 shows a detail of a plan view of a first flange portion of the torsional vibration damper shown in FIG. 3;

FIG. 5 shows a half longitudinal section through the damping device shown in FIG. 1 having a centrifugal force pendulum mounted on the flange portion;

FIG. 6 shows a perspective view of a centrifugal force pendulum of the damping device shown in FIG. 5;

FIG. 7 shows a plan view of the damping device in the mounted state;

FIG. 8 shows a detail, marked in FIG. 7, of the damping device shown in FIG. 7;

FIGS. 9 and 10 show a detail, marked in FIG. 7, of the damping device shown in FIG. 7.

### DETAILED DESCRIPTION

FIG. 1 shows a functional circuit diagram of a drive train 12 of a motor vehicle.

In the functional diagram, a torque transmission, which is designed to be rigid, is shown schematically by means of straight lines. Rotating masses about an axis of rotation 15 are represented symbolically by means of rectangles.

The drive train 12 has a damping device 10, a drive motor 13, a clutch 16 and a transmission device 14. The drive motor 13 is designed by way of example as an internal combustion engine. Alternatively, the drive motor 13 could also be a combination of internal combustion engine and electric machine, which is also referred to as a hybrid drive. The internal combustion engine can be designed as a reciprocating piston engine. Another embodiment of the drive motor 13 would also be conceivable. The transmission device 14 can be designed, for example, as a CVT transmission or as an automatic gearbox.

The damping device 10 has a torsional vibration damper 11, an input side 20 and an output side 25. The input side 20 can be switchably connected to the drive motor 13, in particular the internal combustion engine, in a torque-transmitting manner via the clutch 16. The output side 25 is connected in a rotationally fixed manner to the transmission device 14 by means of a transmission input shaft 35.

The torsional vibration damper 11 has an input part 40, an energy storage element 45 and an output part 50, the input part 40 being rotatable about the axis of rotation 15 against the action of the energy storage element 45 relative to the output part 50. The energy storage element 45 can be designed as a bow spring or as a compression spring 55. When a torque M loaded with a rotational irregularity is introduced by the drive motor 13 into the input side 20, the torsional vibration damper 11 at least partially cancels the rotational irregularity.

Optionally, the damping device 10 has at least one centrifugal force pendulum 170 (shown by dashed lines in FIG. 1), which is arranged on the output part 50. The centrifugal force pendulum 170 is designed to cancel the rotational irregularity in a manner adaptive to the rotational speed.

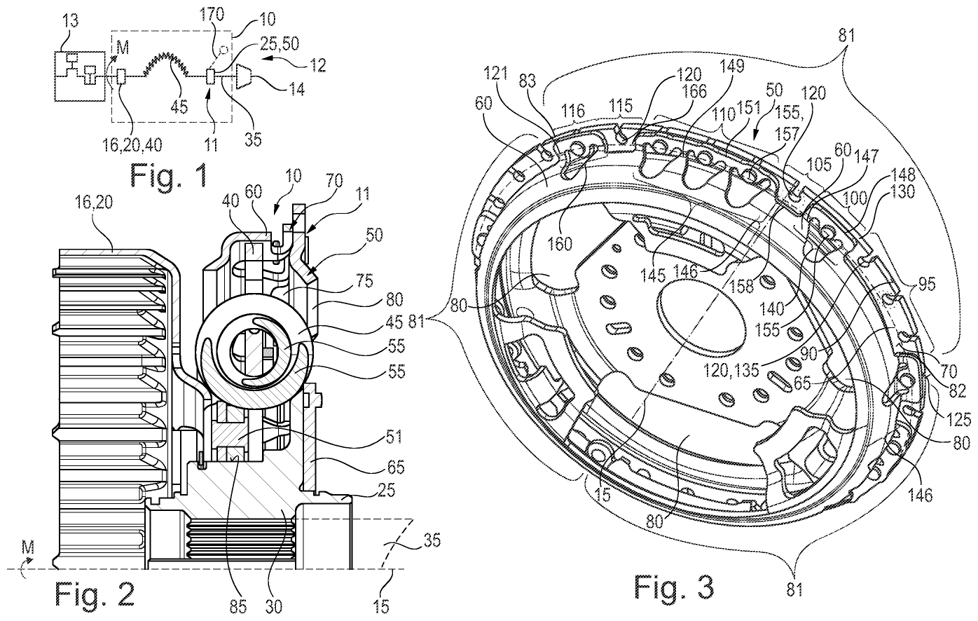

FIG. 2 shows a half longitudinal section through a structural configuration of the damping device 10 shown in FIG. 1.

By way of example, the input side 20 is designed as a disk carrier, in particular as an outer disk carrier of the clutch 16. Another embodiment of the input side 20 would also be conceivable here.

The output side 25 has a hub 30, with the hub 30, for example, being able to engage the transmission input shaft 35 (shown by dashed lines in FIG. 1). The hub 30 connects the transmission input shaft 35 to the output side 25 in a rotationally fixed manner.

The input part 40 is designed in the form of a disk and is connected to the input side 20 in a rotationally fixed manner, for example by means of a rivet connection 51. The energy storage element 45 can have one or more springs. In FIG. 1, for example, the energy storage element 45 comprises two compression springs 55 arranged one inside the other. The compression springs 55 can also be designed with different lengths in the circumferential direction, such that one of the two compression springs 55 has a clearance angle with respect to the other compression spring 55. The energy storage element 45 can also have at least one bow spring.

The output part 50 has a driver element 60 and an output flange 65. The output flange 65 extends substantially in the radial direction and is connected radially on the inside to the hub 30 of the output flange 65 in a rotationally fixed manner.

The output flange 65 has a fastening end face 70 radially on the outside. The fastening end face 70 is arranged, for example, on the side facing the input side 20. The fastening end face 70 can, for example, extend in a plane of rotation to the axis of rotation 15. The driver element 60 is arranged on the fastening end face 70. The driver element 60, together with the output flange 65, delimits a retainer space 75, the energy storage element 45 being arranged in the retainer space 75. The driver element 60 and the output flange 65 fix the energy storage element 45 both in the axial direction and in the radial direction. For this purpose, a window 80, which is arranged radially between the hub 30 and the driver element 60, can be arranged in the output flange 65. The energy storage element 45 can engage in the window 80 in portions.

The input part 40 is mounted on a first outer circumferential side 85 of the hub 30 so as to be rotatable relative to the hub 30. The input part 40 extends in a plane of rotation to the axis of rotation 15 and extends through the retainer space 75 in the radial direction. At a first end of the energy storage element 45, the energy storage element 45 rests against the input part 40. Opposite in the circumferential direction, the energy storage element 45 rests with a second end against the output part 50.

The torque M is introduced into the damping device 10 via the input side 20. The torque M is transmitted to the input part 40 via the rivet connection 51. Depending on the introduced torque M, the input part 40 is rotated against the action of the energy storage element 45 in the circumferential direction relative to the output part 50 and the torque M from the input part 40 is transmitted to the output part 50 via the energy storage element 45. The torque M is further transmitted from the output part 50 to the hub 30 and from the hub 30 into the transmission input shaft 35.

If the drive motor 13 is designed as an internal combustion engine, the torque M is superimposed with a rotational irregularity, in particular a torsional vibration. The torsional vibration is at least partially canceled by rotating the input part 40 back and forth relative to the output part 50, such that the torque M applied at the output side 25 to the transmission input shaft 35 is more uniform than the torque M introduced into the torsional vibration damper 11 at the input side 20.

FIG. 3 shows a perspective view of the output part 50 of the torsional vibration damper 11 shown in FIG. 2.

The output part 50 is divided into a plurality of subregions 81 which are identically designed in the circumferential direction and which each connect to one another in the circumferential direction. The structural design of the output part 50 is explained with reference to the subregion 81 described below. The subregion 81 extends between a first end 82 and a second end 83 in the circumferential direction. The subregion 81 can extend over 120°, for example.

The output part 50 has a plurality of inside windows 80 offset from one another in the circumferential direction, wherein an energy storage element 45 engages in each window 80. The windows 80 are arranged at a distance from a second outer circumferential side 90 of the output flange 65. In each case, a subregion 81 overlaps in the radial direction with a window 80.

The output flange 65 has at least a first flange portion 95 and a second flange portion 100. The first flange portion 95 connects to the first end 82 of the subregion 81 in the circumferential direction. The second flange portion 100 directly connects to the first flange portion 95 in the circumferential direction on the side opposite the first end 82. In addition, the output flange 65 can also have a third flange portion 105, a fourth flange portion 110, a fifth flange portion 115 and a sixth flange portion 116. The flange portions 95, 100, 105, 110, 115, 116 are arranged next to one another in the circumferential direction in relation to the axis of rotation 15.

The third flange portion 105 connects to the second flange portion 100 on a circumferential side facing away from the first flange portion 95. The fourth flange portion 110 connects to the third flange portion 105 in the circumferential direction on the side of the third flange portion 105 facing away from the first flange portion 95. Likewise, the fifth flange portion 115 connects to the fourth flange portion 110 in the circumferential direction on the side of the fourth flange portion 110 facing away from the first flange portion 95. Furthermore, the sixth flange portion 116 connects to the fifth flange portion 115 in the circumferential direction on the side of the fifth flange portion 115 facing away from the first flange portion 95. The sixth flange portion 116 connects to the second end 83 of the subregion 81.

The fastening end face 70 extends beyond the flange portions 95, 100, 105, 110, 115, 116.

At least one first fastening receiver 120 is arranged in the first flange portion 95. A plurality of first fastening receivers 120 arranged to be offset from one another in the circumferential direction is preferably arranged in the first flange portion 95. The first fastening receivers 120 can be arranged at a regular distance from one another in the circumferential direction. The first fastening receivers 120 are arranged on a common pitch circle 121 around the axis of rotation 15. The first fastening receiver 120 is designed as a through-opening in the output flange 65 and extends in the axial direction from the fastening end face 70 to the end face 125 of the output flange 65 arranged axially opposite. The end face 125 is designed to be on the side of the output flange 65 facing away from the input side 20 and extends in a plane of rotation to the axis of rotation 15. The first fastening receiver 120 is designed to be open towards a second outer circumferential side 90. Alternatively, the first fastening receiver 120 could, for example, be designed to be closed radially outward.

A first number of first fastening receivers 120 are designed to be in the first flange portion 95 by way of example. In FIG. 3, for example, three first fastening receivers 120 can be designed. The first fastening receiver 120 is used to accommodate a first fastener 135 (indicated by dashed lines in FIG. 3).

As explained above, the second flange portion 100 connects to the first flange portion 95 in the circumferential direction (counterclockwise in FIG. 2). The second flange portion 100 is designed to be slenderer in the circumferential direction than the first flange portion 95. A second fastening receiver 130 is designed to be in the second flange portion 100. The second fastening receiver 130 can be designed identically to the first fastening receiver 120. In the second flange portion 100 in the embodiment, only a single second fastening receiver 130 is designed to be in the second flange portion 100. The second fastening receiver 130 is designed as a through-opening in the second flange portion 100 and extends from the fastening end face 70 to the end face 125. A plurality of second fastening receivers 130 would also be possible.

The third flange portion 105 and the fifth flange portion 115 are designed to be substantially identical to the first flange portion 95, but the number of first fastening receivers 120 is reduced, for example, compared to the first flange portion 95 since the third and fifth flange portions 105, 115 are designed to be narrower in the circumferential direction than the first flange portion 95. Here, for example, the third flange portion 105 and the fifth flange portion 115 have the same extension in the circumferential direction.

The fourth flange portion 110 and the sixth flange portion 116 are designed to be substantially identical to the second flange portion 100, but the number of second fastening receivers 130 in the fourth flange portion 110 is greater than in the second flange portion 100 and the sixth flange portion 116, for example, because the fourth flange portion 110 is designed to be wider in the circumferential direction than the second and sixth flange portions 100, 116. The sixth flange portion 116 has the same extension in the circumferential direction. In the radial direction, the flange portions 95, 100, 105, 110, 115, 116 are designed to have the same width.

The driver element 60 has a first connection portion 140. In addition, the driver element 60 can have a second connection portion 145, which is arranged to be offset in the circumferential direction and at a distance from the first connection portion 140. The first connection portion 140 can be designed to be narrower in the circumferential direction than the second connection portion 145. The first connection portion 140 is designed to be in a plane of rotation together with the second connection portion 145. The first connection portion 140 is designed in the form of a tab and extends from the radial inside to the radial outside. With a first radially inside end 147, the first connection portion 140 is connected to a holding portion 146 extending substantially in the axial direction. The holding portion 146 carries the energy storage element 45 radially on the outside. A first radially outside end 148 of the first connection portion 140 is arranged radially on the outside approximately at the height of the second outer circumferential side 90.

The second connection portion 145 is designed to be substantially identical to the first connection portion 140 and is connected by a second radially inside end 149 to the holding portion 146. A second radially outside end 151 of the second connection portion 145 is preferably arranged radially at the same height as the second outer circumferential side 90. The second connection portion 145 can extend radially outwards in a tab-like or web-like manner from radially inside.

In the first connection portion 140, the driver element 60 has a third fastening receiver 157, the third fastening receiver 157 being designed, for example, as a through-hole in the first connection portion 140.

In the circumferential direction, the first connection portion 140 delimits a first web receptacle 150 laterally on one side. The first web receptacle 150 is open to the outside in the radial direction. The first web receptacle 150 is delimited in the axial direction by the first flange portion 95. In the first web receptacle 150, the first fastening receiver 120 opens in the axial direction. The first fastening receiver 120 opens in a manner laterally offset with respect to the first and second connection portions 140, 145.

In the circumferential direction opposite the first web receptacle 150, the first connection portion 140 and the second connection portion 145 jointly delimit a second web receptacle 158. In the axial direction, the second web receptacle 158 is delimited on one side by the fastening end face 70 on the third flange portion 105. At least one further third fastening receiver 157 is arranged in the second connection portion 145.

In addition, the driver element 60 can have a third connection portion 160 offset in the circumferential direction relative to the second connection portion 145, wherein the third connection portion 160 is arranged to be offset in the circumferential direction relative to the second connection portion 145. The third connection portion 160 is arranged in the circumferential direction on a side facing away from the first connection portion 140. A third web receptacle 166 is arranged between the second connection portion 145 and the third connection portion 160 and is delimited in the circumferential direction by the second connection portion and the third connection portion 160. The third web receptacle 166 is delimited in the axial direction by the fastening end face 70 on the fifth flange portion 115.

The first fastening receivers 120 arranged in the third and fifth flange portions 105, 115 open both in the second web receptacle 158 and in the third web receptacle 166.

In the mounted state, the second fastening receiver 130 and the third fastening receiver 157 are aligned. A second fastener 155 extends through the second fastening receiver 130 and the third fastening receiver 157 and connects the driver element 60 to the output flange 65 in a form-fitting and/or frictional manner.

The second fastener 155 can be designed as a rivet, for example. Another embodiment of the second fastener 155 would also be conceivable.

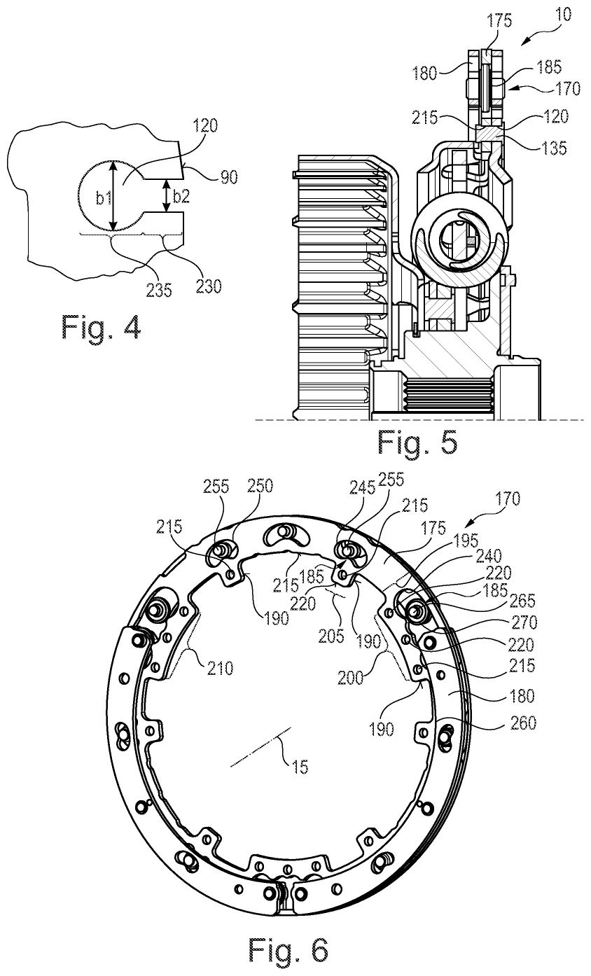

FIG. 4 shows a detail of a plan view of the first flange portion 95.

The first fastening receiver 120 has a first receptacle portion 230 and a second receptacle portion 235 arranged radially on the outside of the first receptacle portion 230. The first receptacle portion 230 has a cross-section with a maximum first extension b1 in the circumferential direction. The cross-section can be circular, elliptical or polygonal. The second receptacle portion 235 extends between the second outer circumferential side 90 and the first receptacle portion 230 and opens both in the second outer circumferential side 90 and in the first receptacle portion 230. The second receptacle portion 235 has a second maximum extension b2 in the circumferential direction, which is smaller than the first maximum extension b1.

FIG. 5 shows a half longitudinal section through the damping device 10 shown in FIG. 1 having a mounted centrifugal force pendulum 170.

The centrifugal force pendulum 170 can optionally be fastened to the torsional vibration damper 11 by means of the first fastener 135. The centrifugal force pendulum 170 has a pendulum flange 175, at least one pendulum mass 180 and at least one coupling means 185. The coupling means 185 can be designed, for example, as a slotted guide. The pendulum mass 180 can, for example, be arranged on both sides of the pendulum flange 175, wherein in FIG. 5 the pendulum flange 175 extends substantially in a plane of rotation.

The coupling means 185 is designed, when the rotational irregularity is introduced into the pendulum flange 175, to guide the pendulum mass 180 along a predefined pendulum path in order to cancel the rotational irregularity of the torque M.

FIG. 6 shows a perspective view of the centrifugal force pendulum 170 shown in FIG. 5.

In the embodiment, the centrifugal force pendulum 170 has a plurality of pendulum masses 180 arranged to be offset from one another in the circumferential direction, wherein only a part of the pendulum masses 180 is shown in FIG. 6. In FIG. 6, the centrifugal force pendulum 170 is designed as an external centrifugal force pendulum 170, wherein the pendulum masses 180 are arranged on both sides of the pendulum flange 175. The centrifugal force pendulum 170 could also be designed as an internal centrifugal force pendulum 170 or as a combination of internal and external centrifugal force pendulums 170.

The pendulum flange 175 has a bearing surface 190 arranged on the end-face side of the pendulum flange 175 on a side facing away from the viewer. The bearing surface 190 is arranged in a plane of rotation perpendicular to the axis of rotation 15.

The pendulum flange 175 has at least a first web portion 200 and an annular portion 195. The annular portion 195 is designed to run around the axis of rotation 15 and runs in a plane of rotation to the axis of rotation 15. The first web portion 200 is arranged on the inside of the annular portion 195. The first web portion 200 extends radially inwards from radially outside.

The pendulum flange 175 preferably has a second web portion 205 and optionally a third web portion 210, wherein the web portions 200, 205, 210 are arranged to be offset relative to one another in the circumferential direction. The web portions 200, 205, 210 and the annular portion 195 are designed to be in one piece and of the same material. The first web portion 200 is, for example, designed to be wider in the circumferential direction than the second and third web portions 205, 210. A configuration of the first web portion 200 corresponds to the first web receptacle 150. The second web portion 205 corresponds to the second web receptacle 158 and the third web portion 210 can be designed to correspond to the third web receptacle 166.

In the radial direction, the web portions 200, 205, 210 are designed with substantially identical extension, such that an inner circumferential side 220 on the web portions 200, 205, 210 extends on a circular path around the axis of rotation 15 over the web portions 200, 205, 210.

The bearing surface 190 is arranged at the end-face side on the web portions 200, 205, 210, wherein the bearing surface 190 extends beyond the web portions 200, 205, 210, for example, in a common plane of rotation. At the end-face side of the annular portion 195, the pendulum mass 180 is arranged on both sides, for example. The coupling means 185 is also designed in portions on the annular portion 195.

Each of the web portions 200, 205, 210 has at least one fourth fastening receiver 215, which is designed to extend in the manner of a bore parallel to the axis of rotation 15.

The coupling means 185 has at least one first recess 240 in the annular portion 195. The coupling means 185 preferably also has a second recess 245 and optionally a third recess 250. The second recess 245 and the third recess 250 are, for example, designed to be kidney-shaped, wherein a center of curvature of the second and third recesses 245, 250 is arranged radially on the inside of the second recess 245 and the third recess 250, respectively. The first recess 240 is designed to be wider in the circumferential direction than the second and third recesses 245, 250.

The coupling means 185 has a pendulum roller 255 for each recess 240, 245, 250. The pendulum roller 255 extends in each case through the second and third recess 245, 250. The pendulum roller 255 engages in a pendulum mass recess 260 associated with the pendulum mass 180. The pendulum mass recess 260 is designed to be kidney-shaped and has a center of curvature which is arranged radially on the outside of the pendulum mass recess 260. The pendulum roller 255 forms, together with the pendulum mass recess 260 and the associated second or third recess 245, 250, a slotted guide, wherein the predefined pendulum path along which the pendulum mass 180 oscillates when the rotational irregularity is introduced in the pendulum flange 175 is defined by means of the slotted guide.

The first recess 240 is arranged radially on the outside of the second web portion 205 and the third recess 250 is arranged, for example, radially on the outside of the third web portion 210. The second recess 245 here has a radial overlap with the second web portion 205 and the third recess 250 has a radial overlap with the third web portion 210. A radial overlap is understood here to mean that when second components, for example the second recess 245 and the second web portion 205, project in the radial direction into a projection plane in which the axis of rotation 15 extends, the two components, for example the second recess 245 and the second web portion 205, overlap in the projection plane.

The pendulum mass 180 is designed, for example, with a radial overlap with the subregion 81 of the output part 50. The first recess 240 likewise has a radial overlap with the first web portion 200. The first recess 240 is designed to be wider in the circumferential direction than the second and third recesses 245, 250 since the first recess 240 is axially penetrated by means of a spacer bolt 265 in each case of two pendulum masses 180 which are arranged next to one another in the circumferential direction in order to axially fasten the two pendulum masses 180 on both sides of the pendulum flange 175. In addition, a damper ring (damper ring?) 270 can be arranged on the spacer bolt 265.

Owing to the radial overlap of the recesses 240, 245, 250 with the web portion 200, 205, 210 arranged radially inside, the centrifugal force pendulum 170 can be designed to be particularly compact in the radial direction. As a result, the centrifugal force pendulum 175 is particularly well suited for optional fastening to the torsional vibration damper 11 shown in FIGS. 1 to 4.

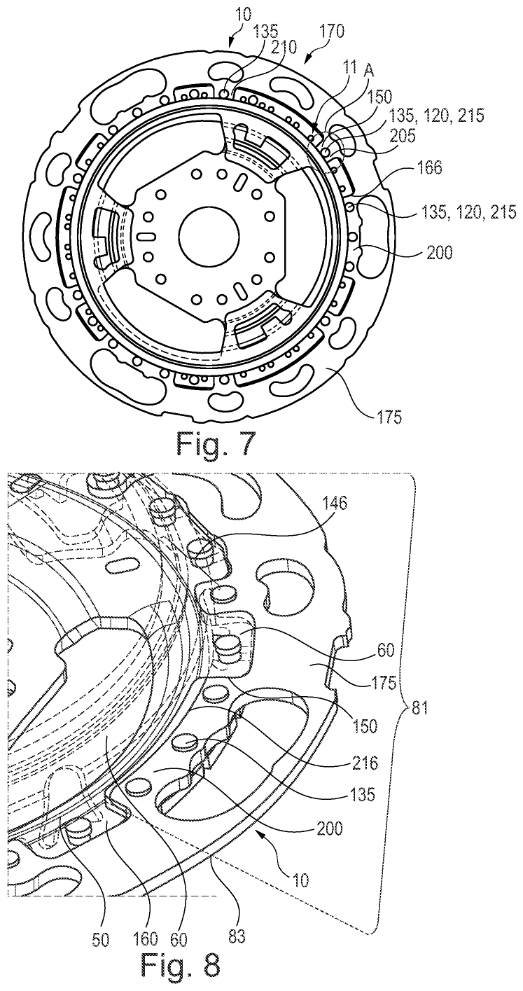

FIG. 7 shows a plan view of the damping device 10 in the mounted state.

Numerous components are not shown in FIG. 7 for reasons of clarity.

In FIG. 7, the centrifugal force pendulum 170 is fastened to the torsional vibration damper 11. The bearing surface 190 of the pendulum flange 175 rests flat against the fastening end face 70. Furthermore, the first web portion 200 and the first flange portion 95 are arranged so as to overlap in the axial direction. Here, an axial overlap is understood to mean that in the case of projection in the axial direction into a projection plane which is arranged perpendicular to the axis of rotation 15, the two components, for example the first web portion 200 and the first flange portion 95, overlap in the projection plane. The first web portion 200 engages in the first web receptacle 150, for example. Likewise, the second web portion 205 engages in the second web receptacle 158 and the third web portion 210 engages in the third web receptacle 166 such that the second web portion 205 and the third flange portion 105 as well as the third web portion 210 and the fifth flange portion 115 are arranged in an axially overlapping manner.

The pendulum flange 175 is positioned in relation to the output flange 65 in such a way that the first fastening receiver 120 and the fourth fastening receiver 215 are aligned. For fastening and axial fixing, the first fastener 135 extends through both the first fastening receiver 120 and the fourth fastening receiver 215.

FIG. 8 shows a detail of a perspective view of the damping device 10 shown in FIG. 7.

The first web receptacle 150 is designed in relation to the first web portion 200 in such a way that an exemplary first gap 216 is arranged between the driver element 60 and the pendulum flange 175 in order to enable easier mounting of the pendulum flange 175 on the torsional vibration damper 11.

It is particularly advantageous here if at least one first cut-out 217 is provided in the holding portion 146 of the driver element 60, which cut-out extends as far as the retainer space 75. The first cut-out 217 and the first web receptacle 150 merge into one another. The first web portion 200 extends through both the first cut-out 217 and the first web receptacle 150 in the radial direction and protrudes into the retainer space 75. The first web portion 200 is designed in the radial direction in such a way that it is designed not to make any contact with the energy storage element 45.

In the circumferential direction, the first web receptacle 150 ends at the second end 83 of the next subregion 81 in the circumferential direction and is delimited by the third connection portion 160 of the next subregion 81.

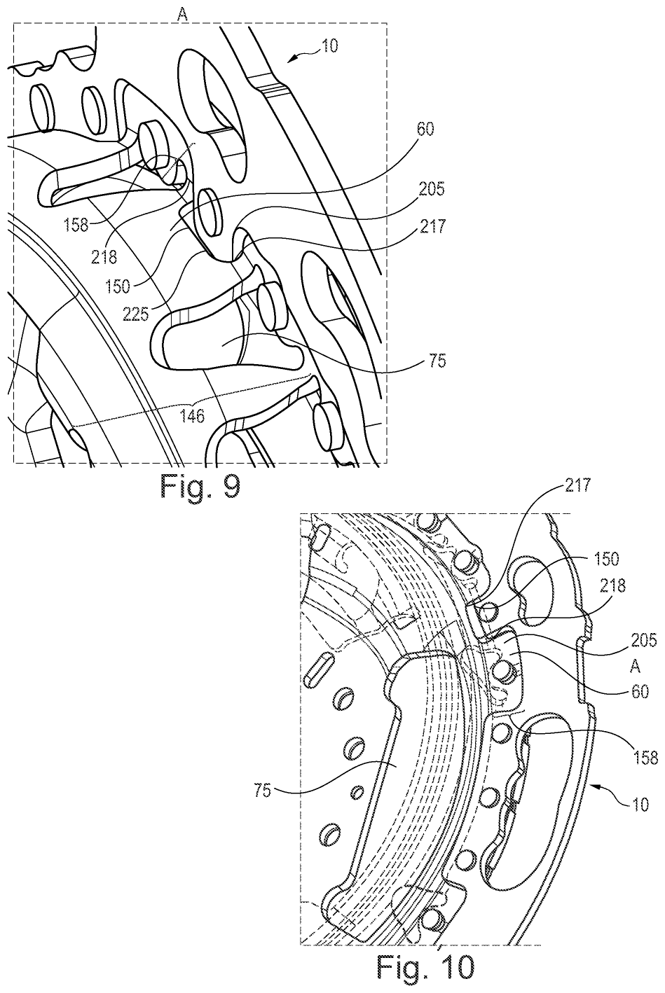

FIGS. 9 and 10 show a detail A, marked in FIG. 7, of the damping device 10 shown in FIG. 7.

The engagement of the second web portion 205 in the second web receptacle 158 is designed similarly to the engagement of the first web portion 200 in the first web receptacle 150. The second web receptacle 158 is also designed in relation to the second web portion 205 in such a way that an exemplary second gap 218 is arranged between the driver element 60 and the pendulum flange 175 in order to enable easier mounting of the pendulum flange 175 on the torsional vibration damper 11.

It is particularly advantageous here if a second cut-out 225 is provided in the holding portion 146 which extends as far as the retainer space 75. The second cut-out 225 extends in the holding portion 146 in the axial direction. The second cut-out and the second web receptacle 158 merge into one another. The second web portion 205 extends through both the second cut-out 225 and the second web receptacle 158 in the radial direction and protrudes into the retainer space 75. The second web portion 205 is designed in the radial direction in such a way that it is designed not to make any contact with the energy storage element 45.

The engagement of the third web portion 210 in the third web receptacle 166 is designed similarly to the engagement of the first web portion 200 in the first web receptacle 150.

In summary, in the embodiment, an outer contour of the driver element 60 is designed in such a way that contact is avoided between the driver element 60 and the pendulum flange 175 so that only forces between the output flange 65 are exchanged with the pendulum flange 175 by means of the first fastener 135. This enables tolerance compensation between the output part 50 and the pendulum flange 175.

To mount the damping device 10, the pendulum flange 175 is preferably positioned first during the mounting of the torsional vibration damper 11 on the output flange 65, followed by the driver element 60. The positioning takes place in such a way that the first fastener 135 and the second fastener 155 can be mounted. As a result, the driver element 60 and the pendulum flange 175 can be connected, in particular riveted, to one another in one production step. It is particularly advantageous here if the first and second fastener 135, 155 are of identical design. In particular, the first and second fastener 135, 155 can have an identical size. Subsequently, the further mounting, for example, of the energy storage element on the driver element 60 in the retainer space 75 is continued.

The configuration of the damping device 10 described in the figures has the advantage that, depending on the design of the damping device 10, the centrifugal force pendulum 170 can be mounted on the output flange 65 without another output flange 65 for the torsional vibration damper 11 having to be mounted. If the centrifugal force pendulum 170 is not mounted, as shown in FIG. 2, the first fastening receiver 120 is unoccupied and the web receptacles 150, 158, 166 are open.

As a result of the configuration of the first fastening receiver 120 shown in FIG. 4, the first outer circumferential side 85 can be positioned radially particularly close to the first fastening receiver 120, such that the torsional vibration damper 11 is particularly compact in the radial direction.

This embodiment has the advantage that the damping device 10 can be flexibly mounted with or without the centrifugal force pendulum 170 by means of the additional mounting option on the torsional vibration damper 11, in particular on the output flange 65, depending on the design of the drive motor 13, without any other components explained in FIGS. 4 to 9 being necessary. In particular, it is not necessary here for the torsional vibration damper 11 to have to be further adapted to fasten the centrifugal force pendulum 170.

The recurring configuration of the subregions 81 in the circumferential direction ensures that the driver element 60 and optionally the pendulum flange 175 are reliably fastened to the output flange 65.

### LIST OF REFERENCE SYMBOLS

10 Damping device
11 Torsional vibration damper
12 Drive train
13 Drive motor
14 Transmission device
15 Axis of rotation
16 Clutch
20 Input side
25 Output side
30 Hub
35 Transmission input shaft
40 Input part
45 Energy storage element
50 Output part
51 First rivet connection
55 Compression spring
60 Driver element
65 Output flange
70 Fastening end face
75 Retainer space
80 Window
81 Subregion
82 First end
83 Second end
85 First outer circumferential side
90 Second outer circumferential side
95 First flange portion
100 Second flange portion
105 Third flange portion
110 Fourth flange portion
115 Fifth flange portion
116 Sixth flange portion
120 First fastening receiver
121 Pitch circle
125 End face
130 Second fastening receiver
135 First fastener
140 First connection portion
145 Second connection portion
146 Holding portion
147 First radially inside end
148 First radially outside end
149 Second radially inside end
150 First web receptacle
151 Second radially outside end
155 Second fastener
157 Third fastening receiver
158 Second web receptacle
160 Third connection portion
166 Third web receptacle
170 Centrifugal force pendulum
175 Pendulum flange
180 Pendulum mass
185 Coupling means
190 Bearing surface
195 Annular portion
200 First web portion
205 Second web portion
210 Third web portion
215 Fourth fastening receiver
216 First gap
217 First cut-out
218 Second gap
220 Inner circumferential side
225 Second cut-out
230 First receptacle portion
235 Second receptacle portion
240 First recess
245 Second recess
250 Third recess
255 Pendulum roller
260 Pendulum mass recess
265 Spacer bolt
270 Damper ring

1. A torsional vibration damper which can be mounted so as to be rotatable about an axis of rotation, the torsional vibration damper comprising:
at least one input part, an energy storage element and an output part,
the input part being rotatable about the axis of rotation against an action of the energy storage element relative to the output part,
the output part having a driver element and an output flange having at least one first flange portion extending in a circumferential direction and a second flange portion adjoining the first flange portion in the circumferential direction and extending in the circumferential direction,
the output flange having a fastening end face extending beyond the first flange portion and the second flange portion,
the driver element having at least one first connection portion extending in a radial direction,
the first connection portion resting against the fastening end face and being connected to the second flange portion,
the output flange in the first flange portion having at least one first fastening receiver, and
the fastening end face of the first flange portion configured to rest against a bearing surface of a pendulum flange of a centrifugal force pendulum and the first fastening receiver configured to receive a first fastener for fastening the pendulum flange in a rotationally fixed manner.

2. The torsional vibration damper according to claim 1, wherein
the driver element includes a second connection portion configured to be offset in the circumferential direction relative to the first connection portion,
the first connection portion delimits a web receptacle in the circumferential direction with the second connection portion,
the output flange delimits the web receptacle with the fastening end face in an axial direction, and
the first fastening receiver opens in the web receptacle and the web receptacle is configured to receive a web portion of the pendulum flange.

3. The torsional vibration damper according to claim 1, wherein:
the first connection portion is configured to extend radially on an outside of the driver element and at least in portions in a plane of rotation to the axis of rotation.

4. The torsional vibration damper according to claim 1, wherein:
the output flange in the first flange portion includes a plurality of first fastening receivers arranged next to one another and being offset relative to one another in the circumferential direction.

5. The torsional vibration damper according to claim 1, wherein:
the output flange in the second flange portion includes at least one second fastening receiver or a plurality of second fastening receivers arranged next to one another in the circumferential direction,
a second fastener engages in the second fastening receiver and connects the first connection portion to the second flange portion, and
the first fastening receiver and the second fastening receiver having a same distance from the axis of rotation.

6. The torsional vibration damper according to claim 1, wherein:
the first fastening receiver extends in an axial direction through the output flange, and
the first fastening receiver is configured to be open radially outward at a first outer circumferential side of the output flange.

7. The torsional vibration damper according to claim 1, wherein:
the first fastening receiver includes a first receptacle portion and a second receptacle portion arranged radially outside of the first receptacle portion,
the first receptacle portion includes a cross-section with a maximum first extension in the circumferential direction,
the second receptacle portion extends between an outer circumferential side and the first receptacle portion and opens both on the outer circumferential side and in the first receptacle portion, and
the second receptacle portion having a second maximum extension in the circumferential direction which is smaller than the first maximum extension.

8. The torsional vibration damper according to claim 1, wherein:
the first fastening receiver is unoccupied and the first flange portion is free.

9. A damping device for a drive train of a motor vehicle, the damping device comprising:
a torsional vibration damper according to claim 2, a centrifugal force pendulum and at least one first fastener,
the centrifugal force pendulum having a pendulum flange, at least one pendulum mass and a coupling means,
the coupling means coupling the pendulum mass to the pendulum flange and configured to guide the pendulum mass along a predefined pendulum path,
the pendulum flange having a bearing surface arranged at an end-face side and a further fastening receiver,
the bearing surface of the pendulum flange resting against the fastening end face on the first flange portion,
the further fastening receiver and the first fastening receiver being at least partially aligned with one another, and
the first fastener engaging at least in portions in the first fastening receiver and the further fastening receiver and connecting the pendulum flange to the output flange.

10. The damping device according to claim 9, wherein:
the pendulum flange includes at least one web portion configured at least in portions in a plane of rotation to the axis of rotation and an annular portion,
the annular portion being arranged circumferentially around the axis of rotation,
the web portion arranged radially on an inside of the annular portion and extending radially inward, and
the web portion engaging in the web receptacle of the torsional vibration damper at least in portions.
